(19) United States
(12) Patent Application Publication
(10) Pub. No.: US 2026/0153632 A1
(43) Pub. Date: Jun. 4, 2026

(54) Binary Offset Carrier Pseudorandom Noise Subcarrier Removal

(71) Applicant: The Boeing Company, Arlington, VA (US)

(72) Inventor: Isaac M. Jeng, Yorba Linda, CA (US)

(21) Appl. No.: 18/965,019

(22) Filed: Dec. 2, 2024

(51) Int. Cl. G01S 19/21

(52) U.S. Cl. CPC G01S 19/21

(57) ABSTRACT

A method for restoring a pseudo random noise from a received binary offset carrier pseudo random noise signal. The received binary offset carrier pseudo random noise signal is filtered using a filter system to form a filtered binary offset carrier pseudo random noise signal that comprises a range of frequencies in the received binary offset carrier pseudo random noise signal. A binary offset carrier is removed from the filtered binary offset carrier pseudo random noise signal to obtain a restored pseudo random noise. The restored pseudo random noise is correlated with a local replica of the pseudo random noise.

### BACKGROUND INFORMATION

### 1. Field

The present disclosure relates generally to communications systems and navigation satellite systems and in particular, to digital data containing binary offset carrier pseudo random noise in satellite signals.

### 2. Background

Navigation satellites are satellites that orbit the Earth and provide positioning, navigation and timing services through a global navigation satellite system (GNSS). These satellite systems include Global Positioning System (GPS), Globalnaya Navigazionnaya Sputnikovaya Sistema (GLONASS), Galileo, BeiDo, and others. These satellites use a medium Earth orbit (MEO). This type of orbit has altitudes of about 20,200 kilometers.

The navigation satellites transmit signals with navigation data such as the location and the time a signal was sent. GPS receivers can detect these signals from multiple satellites to estimate positions on the Earth's surface using a method of trilateration.

The navigation data can be transmitted to a receiver using a sequence such as pseudo random noise (PRN) or binary offset carrier (BOC) pseudo random noise (PRN). A signal contains the navigation data.

Each satellite has a different PRN. The PRN is considered a code that is uniquely assigned to a satellite to distinguish the satellite from other satellites. The signal is spread across a range of frequencies using pseudo random noise.

With BOC PRN, the BOC shifts the signal to different parts of the frequency range defined using the pseudo random noise. The BOC is time multiplexed to the PRN. The use of the BOC separates the main lobe of the PRN into two lobes with one in an upper frequency band and the other in a lower frequency band with respect to the carrier. The separation of the main lobe into two lobes can keep the two main lobes from being jammed around the carrier. This can result in fewer errors.

### SUMMARY

An embodiment of the present disclosure provides a method for processing a received binary offset carrier pseudo random noise signal. The received binary offset carrier pseudo random noise signal is received. The received binary offset carrier pseudo random noise signal comprises a binary offset carrier and a pseudo random noise. The received binary offset carrier pseudo random noise signal is passed through a filter system to form a filtered binary offset carrier pseudo random noise signal that comprises a range of frequencies in the received binary offset carrier pseudo random noise signal. The filtered binary offset carrier pseudo random noise signal is multiplied with a local replica of a binary offset carrier. The binary offset carrier is removed from the filtered binary offset carrier pseudo random noise signal to form a pseudo random noise signal estimate comprising the pseudo random noise and a noise from the filtered binary offset carrier pseudo random noise signal. The noise is removed from the pseudo random noise signal estimate using a noise estimate of the noise and a local replica of the pseudo random noise to obtain a restored pseudo random noise.

Another embodiment of the present disclosure provides a method for restoring a pseudo random noise from a received binary offset carrier pseudo random noise signal. The received binary offset carrier pseudo random noise signal is filtered using a filter system to form a filtered binary offset carrier pseudo random noise signal that comprises a range of frequencies in the received binary offset carrier pseudo random noise signal. The binary offset carrier is removed from the filtered binary offset carrier pseudo random noise signal to obtain a restored pseudo random noise. The restored pseudo random noise is correlated with a local replica of the pseudo random noise.

Still another embodiment of the present disclosure provides a receiver system comprising a signal processor. The signal processor is configured to receive a received binary offset carrier pseudo random noise signal, wherein the received binary offset carrier pseudo random noise signal comprises a binary offset carrier and a pseudo random noise. The signal processor is configured to pass the received binary offset carrier pseudo random noise signal through a filter system to form a filtered binary offset carrier pseudo random noise signal that comprises a range of frequencies in the received binary offset carrier pseudo random noise signal. The signal processor is configured to multiply the filtered binary offset carrier pseudo random noise signal with a local replica of the binary offset carrier, wherein the binary offset carrier is removed from the filtered binary offset carrier pseudo random noise signal to form a pseudo random noise signal estimate comprising the pseudo random noise and a noise from the received binary offset carrier pseudo random noise signal. The signal processor is configured to remove the noise from the pseudo random noise signal estimate using a noise estimate of the noise and a local replica of the pseudo random noise to obtain a restored pseudo random noise. Yet another embodiment of the present

disclosure provides a receiver system configured to filter a received binary offset carrier pseudo random noise signal using a filter system to form a filtered binary offset carrier pseudo random noise signal that comprises a range of frequencies in the received binary offset carrier pseudo random noise signal; remove the binary offset carrier from the filtered binary offset carrier pseudo random noise signal to obtain a restored pseudo random noise; and correlate the restored pseudo random noise with a local replica of the pseudo random noise.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a satellite network in which illustrative embodiments may be implemented;

FIG. 2 is a block diagram of a transmit-receive environment in accordance with an illustrative embodiment;

FIG. 3 is an illustration of a received binary offset carrier pseudo random noise signal and signal components in accordance with an illustrative embodiment;

FIG. 4 is an illustration of a process for restoring pseudo random noise from a received binary offset carrier pseudo random noise signal in accordance with an illustrative embodiment;

FIG. 5 is an illustration of a correlation of a restored pseudo random noise signal in accordance with an illustrative embodiment;

FIG. 6 is an illustration of a flowchart of a process for restoring a pseudo random noise from a received binary offset carrier pseudo random noise signal in accordance with an illustrative embodiment;

FIG. 7 is an illustration of a flowchart of a process for removing a binary offset carrier in accordance with an illustrative embodiment;

FIG. 8 is an illustration of a flowchart of a process for removing noise in accordance with an illustrative embodiment;

FIG. 9 is an illustration of a flowchart of a process for restoring a pseudo random noise from a received binary offset carrier pseudo random noise signal in accordance with an illustrative embodiment;

FIG. 10 is an illustration of a flowchart of a process for performing correlation in accordance with an illustrative embodiment;

FIG. 11 is an illustration of a flowchart of a process for extracting data in accordance with an illustrative embodiment;

FIG. 12 is an illustration of a flowchart of a process for determining a noise estimate in accordance with an illustrative embodiment;

FIG. 13 is an illustration of a flowchart of a process for removing noise in accordance with an illustrative embodiment;

FIG. 14 is an illustration of a flowchart for removing a binary offset carrier in accordance with an illustrative embodiment; and

FIG. 15 is an illustration of a block diagram of a data processing system in accordance with an illustrative embodiment.

### DETAILED DESCRIPTION

The illustrative embodiments recognize and take into account one or more different considerations as described herein. For example, using BOC PRN can result in ambiguities. To navigate, a receiver first acquires the BOC PRN of each satellite in view, and achieves steady tracking of that BOC PRN. The receiver then retrieves navigation data carried by BOC PRN.

An error in tracking a BOC PRN is related to the chipping rate of the BOC PRN and many other parameters. Upon receiving a BOC PRN, the receiver performs a correlation of the received BOC PRN with the local replica of the received BOC PRN. Such correlation is used to acquire and then to track the BOC PRN.

Unlike PRN whose correlation has only one main peak, the binary offset carrier in a BOC PRN gives multiple peaks in the BOC PRN correlation. When the BOC PRN correlation is used for acquisition, these multiple peaks cause ambiguities. Likewise, these multiple peaks also cause ambiguities in tracking. Additive noise in a BOC PRN further increases ambiguities in tracking. The ambiguities can result in at least one of errors in tracking or taking increased amounts of time to identifying the correct peak. This increase in time to identify the correct peak can reduce performance in tracking the BOC PRN.

Further, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

As used herein, “a number of” when used with reference to items, means one or more items. For example, “a number of items” is one or more items.

Thus, the illustrative examples provide a method, apparatus, system, and computer program product for a method for restoring a pseudo random noise from a received binary offset carrier pseudo random noise signal. The received binary offset carrier pseudo random noise signal is filtered using a filter system to form a filtered binary offset carrier pseudo random noise signal that comprises a range of frequencies in the received binary offset carrier pseudo random noise signal. The binary offset carrier is removed from the filtered binary offset carrier pseudo random noise signal to obtain a restored pseudo random noise. The restored pseudo random noise is correlated with a local replica of the pseudo random noise.

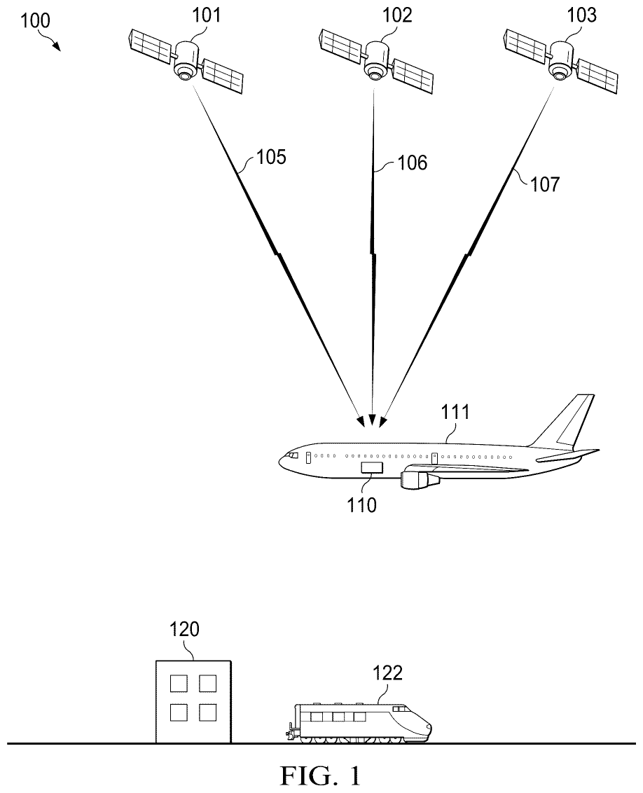

With reference now to the figures and, in particular, with reference to FIG. 1, a pictorial representation of a satellite network is depicted in which illustrative embodiments may be implemented. In this example, satellite network 100 includes satellite 101, satellite 102, and satellite 103. Lights can be part of the constellation of navigation satellites that provide navigation information that can be detected by receiver system 110 in aircraft 111. As depicted, satellite 101 transmits binary offset carrier (BOC) pseudo random noise (PRN) signals 105; satellite 102 transmits binary offset carrier (BOC) pseudo random noise (PRN) signals 106; and satellite 103 transmits binary offset carrier (BOC) pseudo random noise (PRN) signals 107. These binary offset carrier (BOC) pseudo random noise (PRN) signals contain navigation information that can be received by receiver system 110 in aircraft 111.

Receiver system 110 can determine which binary offset carrier (BOC) pseudo random noise (PRN) signals are received from a particular satellite.

For example, receiver system 110 can receive binary offset carrier (BOC) pseudo random noise (PRN) signals 106 and determine that these signals are received from satellite 102. Binary offset carrier (BOC) pseudo random noise (PRN) signals 106 contain pseudo random noise that is unique to satellite 102. In similar fashion, the pseudo random noise in binary offset carrier (BOC) pseudo random noise (PRN) signals 105 is unique to satellite 101, and pseudo random noise in binary offset carrier (BOC) pseudo random noise (PRN) signals 107 is unique to satellite 103.

In this illustrative example, the identification of which signals are received from which satellites can be performed at least one of more quickly or without ambiguities that occur using present techniques. In this example, receiver system 110 needs to achieve steady tracking of the binary offset carrier pseudo random noise (PRN) signals 106 transmitted from satellite 102.

Thus, receiver system 110 can achieve steady tracking of binary offset carrier (BOC) pseudo random noise (PRN) signals 106 from satellite 102 to retrieve navigation data from that satellite. This tracking is performed with reduced errors when correlating received binary offset carrier (BOC) pseudo random noise (PRN) signals with local replicas of these signals.

For example, binary offset carrier pseudo random noise (PRN) signals are received as received binary offset carrier pseudo random noise (PRN) signals. Processing is performed to determine whether the binary offset carrier pseudo random noise signals are binary offset carrier pseudo random noise (PRN) signals 106 from satellite 102.

The received binary offset carrier pseudo random noise signals are passed through a low-pass filter. This low-pass filter is used to select a range of frequencies in received binary offset carrier pseudo random noise signals. The filtered signals are multiplied by a binary offset carrier for the binary offset carrier (BOC) pseudo random noise (PRN) signals. Noise statistics on are estimated for the binary offset carrier (BOC) pseudo random noise (PRN) signals. These noise estimates can be the absolute value of the received binary offset carrier pseudo random noise signals.

A function is generated to remove the subcarrier from received binary offset carrier pseudo random noise signals. In this example, the subcarrier is the binary offset carrier. The binary offset carrier is removed from received binary offset carrier pseudo random noise (PRN) signals to form restored pseudo random noise, based on a local copy of pseudo random noise. Correlation is performed using this restored pseudo random noise and the local copy of the pseudo random noise to determine whether the received binary offset carrier pseudo random noise signals are binary offset carrier pseudo random noise (PRN) signals 106 from satellite 102.

When the correlation is present and the correlation peak exceeds a defined threshold, received binary offset carrier pseudo random noise (PRN) signals are binary offset carrier pseudo random noise (PRN) signals 106 from satellite 102. The correlation peak is where the greatest amount or level of matching that occurs from correlating the restored pseudo random noise and the local copy of the pseudo random noise to each other. In this example, the correlation peak can be considered the correct peak, when the correlation peak exceeds a defined threshold. This threshold can be selected to avoid correlations resulting from noise. The navigation information can then be extracted from the received binary offset carrier pseudo random noise signals.

Similar processing is performed on received binary offset carrier pseudo random noise signals to identify binary offset carrier pseudo random noise (PRN) signals 105 from satellite 101 and binary offset carrier pseudo random noise (PRN) signals 107 from satellite 103.

As described in this illustrative example, the correlation with at least one of increased speed or reduced, or in absence of, ambiguities can occur by reducing the number of peaks that are correlated. In these examples, the binary offset carrier (BOC) is removed from the binary offset carrier (BOC) pseudo random noise (PRN) signals. The remaining portions of the signal are processed to restore the pseudo random noise. This restored pseudo random noise is compared with a local replica of the pseudo random noise for a particular satellite to determine whether the signals have been received from that satellite. As a result, data can be retrieved from the correct signals originating from different satellites or other sources.

The illustration of signals by receiver system 110 and aircraft 111 is provided as one example and not meant to limit the manner in which other illustrative examples can be implemented. For example, receivers can also be present in other platforms such as building 120 and train 122. Receivers in these platforms can also receive satellite signals and process those signals to perform correlation and extraction of data. As another example, the binary offset carrier pseudo random noise signals can be transmitted from other platforms other than satellites. For example, the signals can be transmitted from a space station, a ground station, an aircraft, a ship, or some other suitable platform that can transmit information. Further, this information can be information other than navigation information. For example, the information can include files, instructions, programs, images, or other types of information.

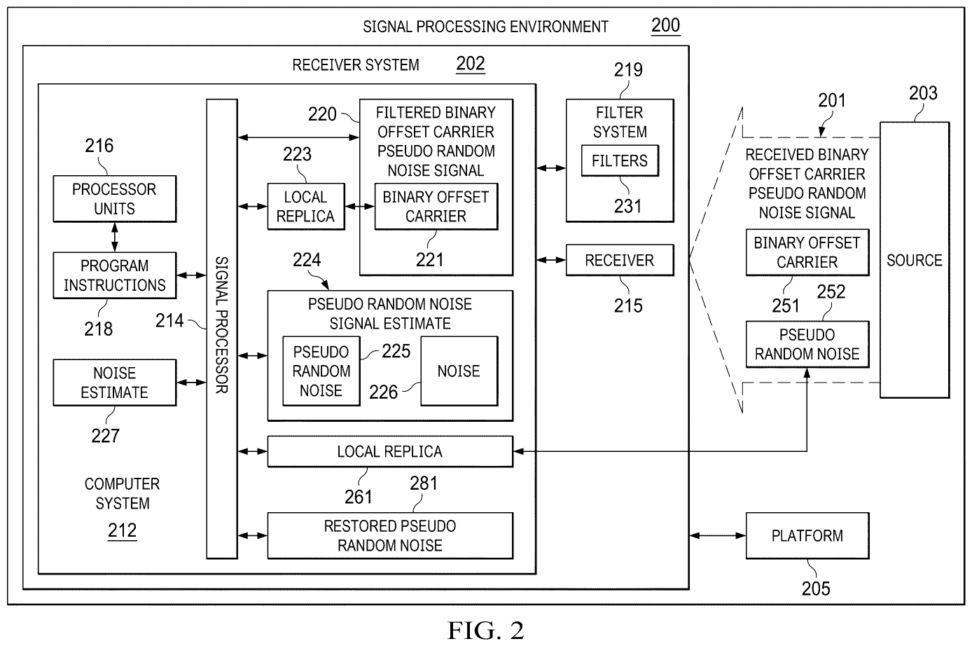

With reference now to FIG. 2, an illustration of a block diagram of a signal processing environment is depicted in accordance with an illustrative embodiment. In this illustrative example, signal processing environment 200 includes components that can be implemented in hardware such as receiver system 110 and aircraft 111 in FIG. 1.

In this illustrative example, received binary offset carrier pseudo random noise signal 201 is transmitted by source 203 and received by receiver system 202. Received binary offset carrier pseudo random noise signal 201 comprises binary offset carrier 251 and pseudo random noise 252.

Receiver system 202 is located on platform 205.

Platform 205 and source 203 can take a number of different forms. For example, platform 205 and source 203 can be selected from a group comprising a mobile platform, a stationary platform, a land-based structure, an aquatic-based structure, a space-based structure, an aircraft, a commercial aircraft, a rotorcraft, a tilt-rotor aircraft, a tilt wing aircraft, a vertical takeoff and landing aircraft, an electrical vertical takeoff and landing vehicle, a personal air vehicle, a surface ship, a tank, a personnel carrier, a train, a spacecraft, a space station, a satellite, a submarine, an automobile, a power plant, a bridge, a dam, a house, a manufacturing facility, a building, and other suitable platforms.

In one example, source 203 is a satellite in a global navigation satellite system. With this example, pseudo random noise 252 uniquely identifies the satellite within the global navigation satellite system. In other words, pseudo random noise 252 in received binary offset carrier pseudo random noise signal 201 is unique to this satellite. Other satellites in this global navigation satellite system will have other pseudo random noise. As a result, signals from the satellite can be distinguished from other satellites when receiving information from a satellite.

In this illustrative example, receiver system 202 comprises computer system 212, signal processor 214, and receiver 215. Receiver 215 is hardware that the text signals such as received binary offset carrier pseudo random noise signal 201. Receiver 215 includes an antenna and can include other components such as at least one of an amplifier, a filter, an analog-to-digital converter, and other suitable components for detecting received binary offset carrier pseudo random noise signal 201.

Receiver system 202 can operate to determine the source of a signal received by receiver system 202. For example, signals can be received from multiple sources such as satellites. With this example, receiver system 202 may desire to receive data or information from a particular satellite. Receiver system 202 can process the signals to identify signals transmitted by that particular satellite.

In this illustrative example, receiver system 202 is comprised of a number of different components. As depicted, receiver system 202 comprises computer system 212, signal processor 214, and receiver 215. In this example, signal processor 214 is located in computer system 212. Signal processor 214 can be implemented in software, hardware, firmware or a combination thereof. When software is used, the operations performed by signal processor 214 can be implemented in program instructions configured to run on hardware, such as a processor unit. When firmware is used, the operations performed by signal processor 214 can be implemented in program instructions and data can be stored in persistent memory to run on a processor unit. When hardware is employed, the hardware can include circuits that operate to perform the operations in signal processor 214.

In the illustrative examples, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Computer system 212 is a physical hardware system and includes one or more data processing systems. When more than one data processing system is present in computer system 212, those data processing systems are in communication with each other using a communications medium. The communications medium can be a network. The data processing systems can be selected from at least one of a computer, a server computer, a tablet computer, or some other suitable data processing system.

As depicted, computer system 212 includes a number of processor units 216 that are capable of executing program instructions 218 implementing processes in the illustrative examples. In other words, program instructions 218 are computer-readable program instructions.

As used herein, a processor unit in the number of processor units 216 is a hardware device and is comprised of hardware circuits such as those on an integrated circuit that respond to and process instructions and program code that operate a computer.

When the number of processor units 216 executes program instructions 218 for a process, the number of processor units 216 can be one or more processor units that are in the same computer or in different computers. In other words, the process can be distributed between processor units 216 on the same or different computers in computer system 212.

Further, the number of processor units 216 can be of the same type or different types of processor units. For example, the number of processor units 216 can be selected from at least one of a single core processor, a dual-core processor, a multi-processor core, a general-purpose central processing unit (CPU), a graphics processing unit (GPU), a digital signal processor (DSP), or some other type of processor unit.

In one illustrative example, signal processor 214 filters received binary offset carrier pseudo random noise signal 201 using filter system 219 to form a filtered binary offset carrier pseudo random noise signal 220. In this example the signal can also be down-converted to baseband. Filter system 219 is a number of filters 231. These filters can be selected to obtain frequencies in a range of interest in received binary offset carrier pseudo random noise signal 201. The number of filters 231 in filter system 219 can be selected from at least one of a low pass filter, a high pass filter, a band pass filter, a notch filter, or some other suitable filter. For example, filter system 219 can be a low pass filter (LPF) that selects frequencies in a range of interest in received binary offset carrier pseudo random noise signal 201.

In this example, filtered binary offset carrier pseudo random noise signal 220 comprises a range of frequencies in received binary offset carrier pseudo random noise signal 201.

Signal processor 214 removes binary offset carrier 221 from filtered binary offset carrier pseudo random noise signal 220 to obtain restored pseudo random noise 281. Signal processor 214 can remove binary offset carrier 221 multiplying filtered binary offset carrier pseudo random noise signal 220 with local replica 223 of binary offset carrier 221. This multiplication removes binary offset carrier 221 from filtered binary offset carrier pseudo random noise signal 220 to form a pseudo random noise signal estimate 224. In these examples, a local replica is a copy of a signal or information that is local to the receiver or system that receives a binary offset carrier pseudo random noise signal.

In this example, pseudo random noise signal estimate 224 comprises pseudo random noise 225 and noise 226 from the filtered binary offset carrier pseudo random noise signal 220. Next, signal processor 214 removes noise 226 from pseudo random noise signal estimate 224 to obtain restored pseudo random noise 281. Signal processor 214 can remove noise 226 in a number of different ways.

In one illustrative example, signal processor 214 determines noise estimate 227 for noise 226 in received binary offset carrier pseudo random noise signal 201 as a standard deviation of an absolute value of filtered binary offset carrier pseudo random noise signal 220. Signal processor 214 adds noise estimate 227 to pseudo random noise signal estimate 224. Signal processor 214 applies a sign function to the pseudo random noise signal estimate 224 with noise estimate 227 to obtain restored pseudo random noise 281.

In this illustrative example, signal processor 214 correlates restored pseudo random noise 281 with local replica 261 of pseudo random noise 252. This correlation is performed to find a best match between local replica 261 and restored pseudo random noise 281.

In this example, the correlation can be considered to be present in response to a correlation peak that satisfies a defined threshold. In this illustrative example, the correlation peak is a greatest level of correlation between the restored pseudo random noise 281 and the local replica 261 of pseudo random noise 252 in response to comparing restored pseudo random noise 281 and the local replica 261 of pseudo random noise 252 to each other.

Further in this example, the defined threshold is a value that is a selected value of when a correct correlation is present. The defined threshold can be selected to avoid correlation peaks resulting from noise. For example, the defined threshold can be selected based on analysis of the binary offset carrier pseudo random noise or pseudo random noise involved in correlation. The selection can take into account the number of chips in the binary offset carrier pseudo random noise or binary offset carrier pseudo random noise in correlation. Since the number of chips involved in correlation changes during either acquisition process or tracking process, this defined threshold can also change.

The correlation enables tracking or locking on to signals transmitted by source 203. Signal processor 214 can extract data from the received binary offset carrier pseudo random noise signal 201 in response to a correlation being present between local replica 261 and restored pseudo random noise 281.

Thus, in the illustrative examples, correlation of pseudo random noise in the received binary offset carrier pseudo random noise signal to local replica 261 enables tracking of received binary offset carrier pseudo random noise signal 201. In these examples, the pseudo random noise is obtained from this signal as the restored pseudo random noise. This correlation can be performed in these examples without ambiguities through the removal of the binary offset carrier from the received binary offset carrier pseudo random noise signal.

The source of interest has pseudo random noise that is unique to that source as compared to other sources. As a result, the process in the illustrative example enables tracking signals from a source of interest such as a navigation satellite. With this tracking, data can be extracted from the received binary offset carrier pseudo random noise signal transmitted by the source. Thus, the illustrative examples can provide reduced ambiguity that can provide at least one of reduced error or reduced amount of time in identifying signals from the source.

In one illustrative example, one or more technical solutions are present that overcome a technical problem with ambiguity in correlating signals from sources such as binary offset carrier pseudo random noise signals. In these examples, ambiguity is reduced through the removal of the binary offset carrier from binary offset carrier pseudo random noise signals resulting in fewer peaks for correlation. As a result, the correlation can be performed with at least one of less error or less time.

The illustration of signal processing environment 200 in FIG. 2 is not meant to imply physical or architectural limitations to the manner in which an illustrative embodiment may be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment.

For example, one or more sources can be present in addition to source 203 that transmit binary offset carrier pseudo random noise signals. Signal processor 214 can identify one or more sources of interest and correlate binary offset carrier pseudo random noise signals as described with respect to received binary offset carrier pseudo random noise signal 201 in a manner that produces ambiguity for these correlations. In yet another illustrative example, receiver system 202 can include one or more receivers in addition to receiver 215. Each of these receivers can acquire and track binary offset carrier pseudo random noise signals from different sources.

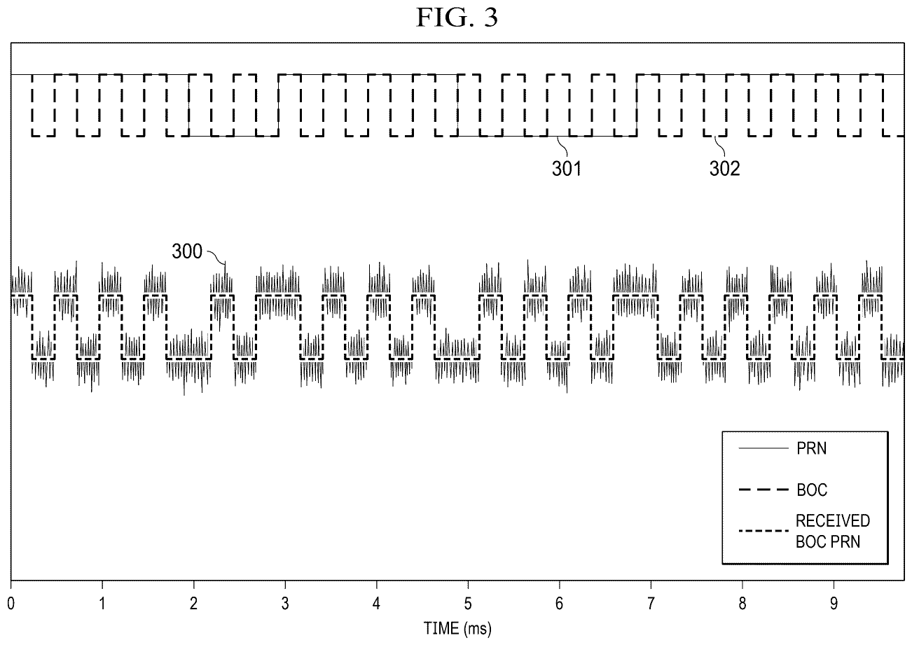

Turning now to FIG. 3, an illustration of a received binary offset carrier pseudo random noise signal and signal components signal is depicted in accordance with an illustrative embodiment. As depicted, received BOC PRN 300 is an example of received binary offset carrier pseudo random noise signal 201 in FIG. 2. In this example, PRN 301 and BOC 302 are components in received BOC PRN 300. PRN 301 is an example of pseudo random noise 252 in FIG. 2 and BOC 302 is an example of binary offset carrier 251 in FIG. 2.

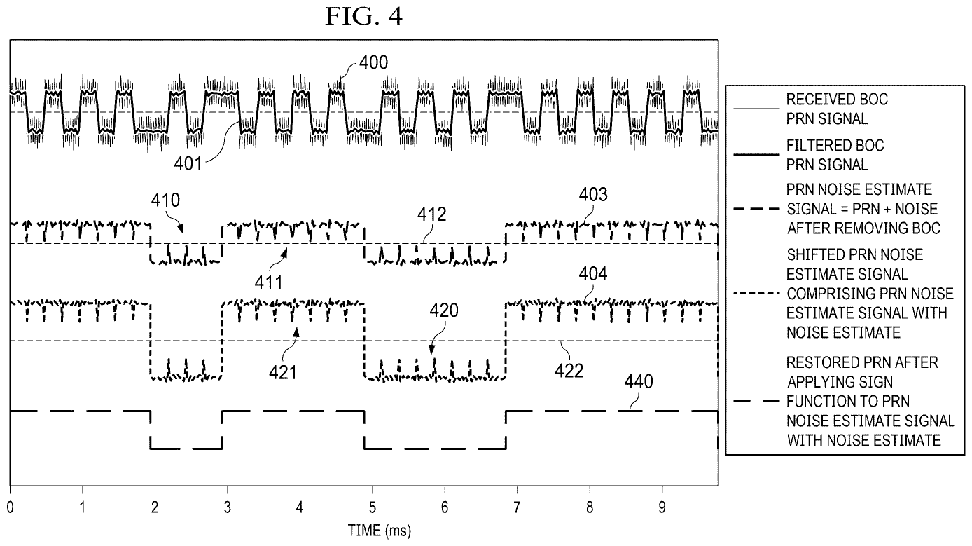

With reference next to FIG. 4, an illustration of a process for restoring pseudo random noise from a received binary offset carrier pseudo random noise signal is depicted in accordance with an illustrative embodiment. In this example, Received BOC PRN Signal 400 is an example of received binary offset carrier pseudo random noise signal 201 in FIG. 2.

In this example, Filtered BOC PRN Signal 401 is obtained in response to filtering Received BOC PRN Signal 400 using a filtering system. In this example, the filtering system is a low pass filter. Filtered BOC PRN Signal 401 is an example of filtered binary offset carrier pseudo random noise signal 220 in FIG. 2.

PRN Noise Estimate Signal 403 is generated from removing BOC from Filtered BOC PRN Signal 401. The BOC can be removed by multiplying Filtered BOC PRN Signal 401 by a local replica of the BOC in Filtered BOC PRN Signal 401. In this example, PRN Noise Estimate Signal 403 comprises the PRN in Filtered BOC PRN Signal 401 and noise in Filtered BOC PRN Signal 401.

As depicted, peaks 410 and troughs 411 in PRN Noise Estimate Signal 403 are at zero line 412. This location of peaks 410 and troughs 411 can cause undesired zeros to occur when processing PRN Noise Estimate Signal 403 to obtain restored PRN 440.

As a result in this example, noise is estimated for Received BOC PRN Signal 400 and is added to PRN Noise Estimate Signal 403 to result in shifted PRN Noise Estimate Signal 404. The addition of the noise shifts peaks 420 and troughs 421 in Shifted PRN Noise Estimate Signal 404 away from zero line 422.

Restored PRN 440 is obtained from applying a sign function to Shifted PRN Noise Estimate Signal 404. This restored PRN can be used to determine a correlation of the PRN without ambiguities.

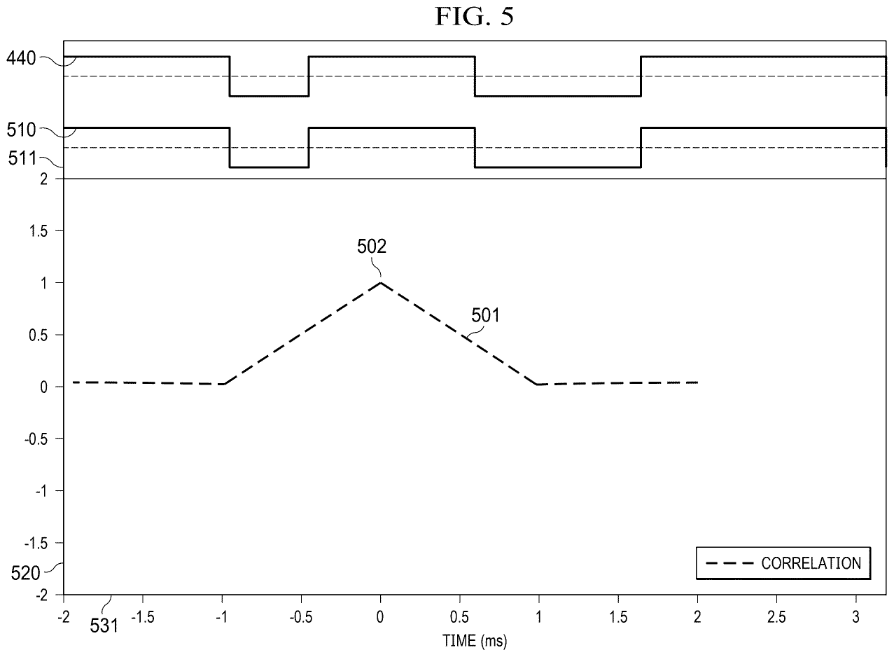

With reference now to FIG. 5, an illustration of a correlation of a received binary offset carrier pseudo random noise signal is depicted in accordance with an illustrative embodiment. In this example, correlation line 501 in graph 511 shows the level of correlation from performing a correlation between restored PRN 440 in FIG. 4 and local copy 510 of the pseudo random noise. In this example, local copy 510 is associated with the source for which signals are to be binary offset carrier pseudo random noise signals. In this example, y-axis 520 is the amount of correlation and x-axis 531 is the time offset or delay applied to local copy 510 to align this copy with Restored PRN 440.

As depicted, correlation peak 502 is where the greatest match is present between Restored PRN 440 in FIG. 4 and local copy 510 of the PRN. In this example, correlation peak 502 occurs at a delta t of zero. In this example, the correlation occurs without ambiguity.

The positioning of Restored PRN 440 relative to local copy 510 of the PRN results in correlation peak 502 in correlation line 501. In this example, x-axis 531 shows the alignment between Restored PRN 440 and local copy 510.

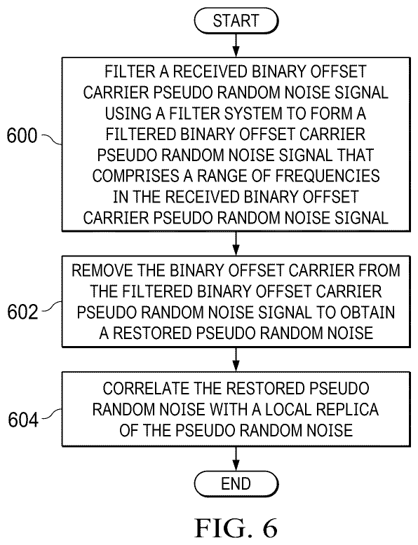

Turning next to FIG. 6, an illustration of a flowchart of a process for restoring a pseudo random noise from a received binary offset carrier pseudo random noise signal is depicted in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in signal processor 214 in computer system 212 in FIG. 2.

The process filters a received binary offset carrier pseudo random noise signal using a filter system to form a filtered binary offset carrier pseudo random noise signal that comprises a range of frequencies in the received binary offset carrier pseudo random noise signal (operation 600). The process removes the binary offset carrier from the filtered binary offset carrier pseudo random noise signal to obtain a restored pseudo random noise (operation 602).

The process correlates the restored pseudo random noise with a local replica of the pseudo random noise (operation 604). The process terminates thereafter.

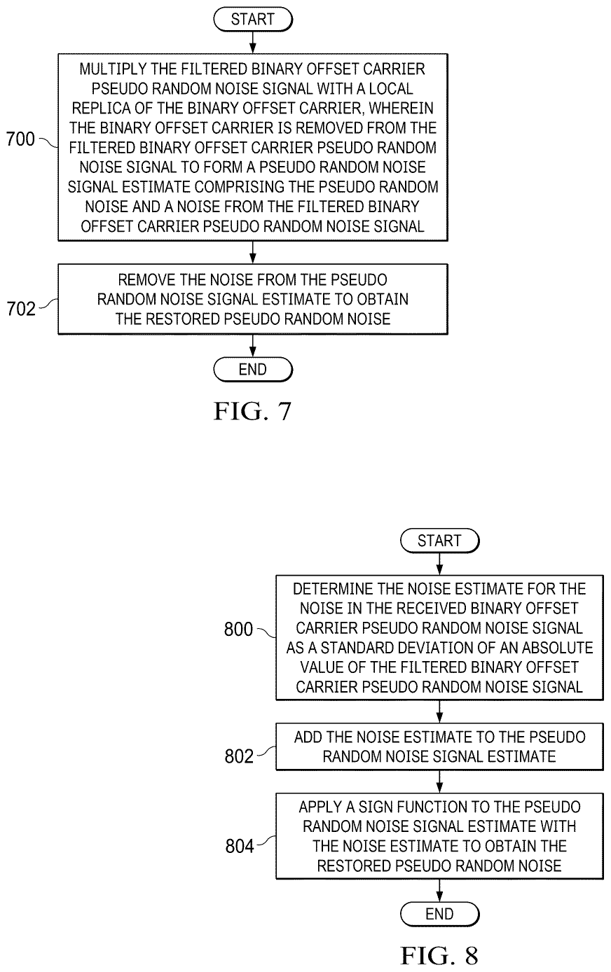

With reference next to FIG. 7, an illustration of a flowchart of a process for removing a binary offset carrier is depicted in accordance with an illustrative embodiment. The process in FIG. 7 is an example of an implementation for operation 602 in FIG. 6.

The process multiplies the filtered binary offset carrier pseudo random noise signal with a local replica of the binary offset carrier, wherein the binary offset carrier is removed from the filtered binary offset carrier pseudo random noise signal to form a pseudo random noise signal estimate comprising the pseudo random noise and a noise from the filtered binary offset carrier pseudo random noise signal (operation 700). The process removes the noise from the pseudo random noise signal estimate to obtain the restored pseudo random noise (operation 702). The process terminates thereafter.

Turning to FIG. 8, an illustration of a flowchart of a process for removing noise is depicted in accordance with an illustrative embodiment. The process in FIG. 7 is an example of an implementation for operation 702 in FIG. 7.

The process determines the noise estimate for the noise in the received binary offset carrier pseudo random noise signal as a standard deviation of an absolute value of the filtered binary offset carrier pseudo random noise signal (operation 800). In operation 900 the standard deviation can be multiplied by 6. The value of the multiplier is selected to cause the noise estimate to cover a range of noise values. In this example, the use of 6 covers more than 99% of the range of noise values. Lower values cover a lower range of noise values. The process adds the noise estimate to the pseudo random noise signal estimate (operation 802).

The process applies a sign function to the pseudo random noise signal estimate with the noise estimate to obtain the restored pseudo random noise (operation 804). The process terminates thereafter.

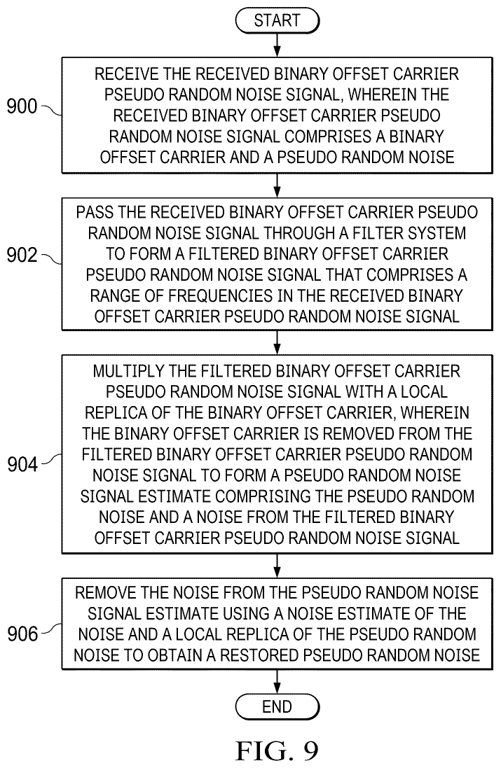

Turning next to FIG. 9, an illustration of a flowchart of a process for restoring a pseudo random noise from a received binary offset carrier pseudo random noise signal is depicted in accordance with an illustrative embodiment. The process in FIG. 9 can be implemented in hardware, software, or both. When implemented in software, the process can take the form of program instructions that are run by one of more processor units located in one or more hardware devices in one or more computer systems. For example, the process can be implemented in signal processor 214 in computer system 212 in FIG. 2.

The process receives the received binary offset carrier pseudo random noise signal, wherein the received binary offset carrier pseudo random noise signal comprises a binary offset carrier and a pseudo random noise (operation 900). The process passes the received binary offset carrier pseudo random noise signal through a filter system to form a filtered binary offset carrier pseudo random noise signal that comprises a range of frequencies in the received binary offset carrier pseudo random noise signal (operation 902). In operation 902, the filtering can also include down converting the signal to a baseband.

The process multiplies the filtered binary offset carrier pseudo random noise signal with a local replica of the binary offset carrier, wherein the binary offset carrier is removed from the filtered binary offset carrier pseudo random noise signal to form a pseudo random noise signal estimate comprising the pseudo random noise and a noise from the filtered binary offset carrier pseudo random noise signal (operation 904).

The process removes the noise from the pseudo random noise signal estimate using a noise estimate of the noise and a local replica of the pseudo random noise to obtain a restored pseudo random noise (operation 906). The process terminates thereafter.

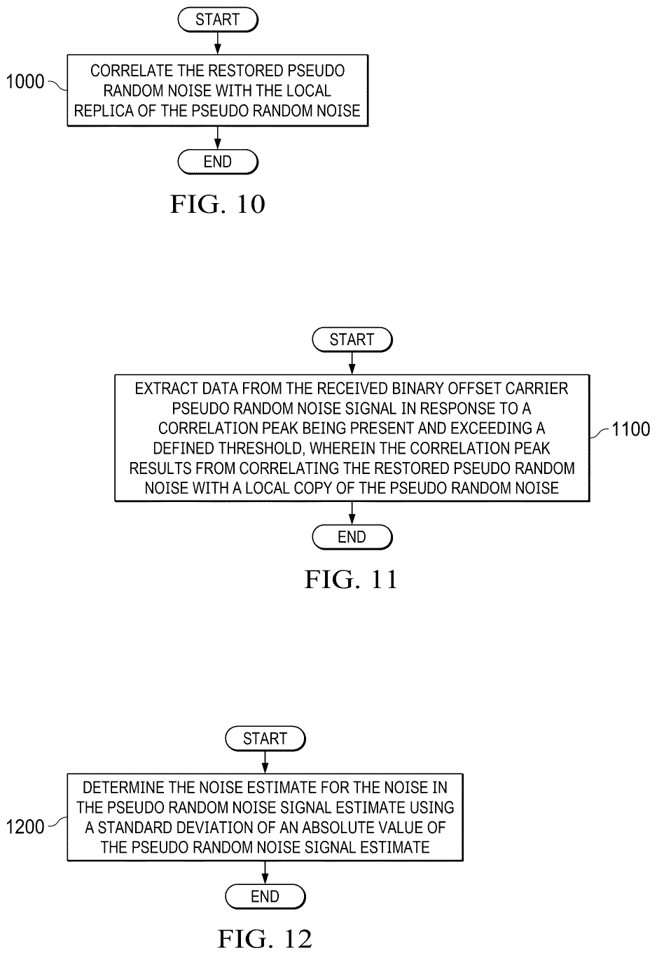

With reference now to FIG. 10, an illustration of a flowchart of a process for performing correlation is depicted in accordance with an illustrative embodiment. The process in this flowchart is an example of an operation that can be performed with the operations in FIG. 9.

The process correlates the restored pseudo random noise with the local replica of the pseudo random noise (operation 1000). The process terminates thereafter.

Next in FIG. 11, an illustration of a flowchart of a process for extracting data is depicted in accordance with an illustrative embodiment. The process in this flowchart is an example of an operation that can be performed with the operations in FIG. 9 and FIG. 10.

The process extracts data from the received binary offset carrier pseudo random noise signal in response to a correlation peak being present and exceeding a defined threshold, wherein the correlation peak results from correlating the restored pseudo random noise with a local copy of the pseudo random noise (operation 1100). The process terminates thereafter.

Turning to FIG. 12, an illustration of a flowchart of a process for determining a noise estimate is depicted in accordance with an illustrative embodiment. The process in this figure is an example of an additional operation that can be performed with the operations in FIG. 9.

The process determines the noise estimate for the noise in the pseudo random noise signal estimate using a standard deviation of an absolute value of the pseudo random noise signal estimate (operation 1200). The process terminates thereafter. In operation 1200 the standard deviation can be multiplied by a value such as 6 to cover a desired range of noise.

In this example, the noise estimate in operation 1300 is calculated by adding the product of 6 multiplied by the noise signal sigma to the pseudo random noise signal estimate. This operation is followed with applying a sign function to the pseudo random noise signal estimate with the product of 6 multiplied by the noise sigma estimate added to obtain the restored pseudo random noise.

In this example, the noise sigma can be a calculation of the size of the noise. In this example, noise sigma is about 68% of how much the noise varies. Further in this example, the sign function is if >0, =1 and if <0, −1.

Further in this example, the noise estimate is used to move peaks or troughs in the pseudo random noise signal estimate away from zero. This shift reduces zeros when applying the sign function.

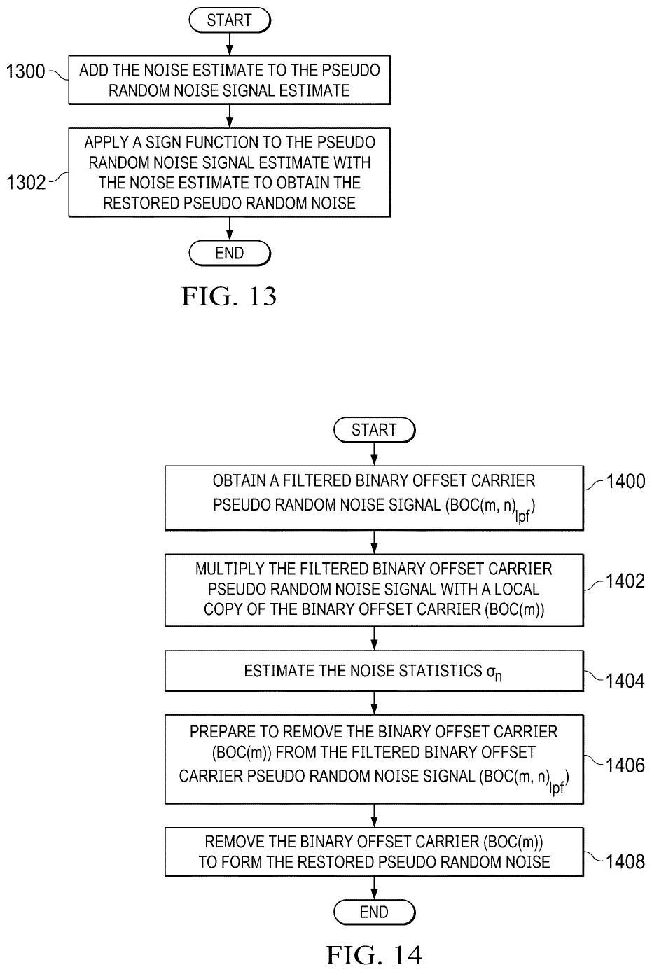

Turning now to FIG. 13, an illustration of a flowchart of a process for removing noise is depicted in accordance with an illustrative embodiment. The process in this flowchart is an example of an implementation for operation 906 in FIG. 9.

The process adds the noise estimate to the pseudo random noise signal estimate (operation 1300). The process applies a sign function to the pseudo random noise signal estimate with the noise estimate to obtain the restored pseudo random noise (operation 1302). The process terminates thereafter.

With reference to FIG. 14, an illustration of a flowchart for removing a binary offset carrier is depicted in accordance with an illustrative embodiment. The process in FIG. 14 can be implemented in hardware, software, or both. When implemented in software, the process can take the form of program instructions that are run by one of more processor units located in one or more hardware devices in one or more computer systems. For example, the process can be implemented in signal processor 214 in computer system 212 in FIG. 2.

The process obtains a filtered binary offset carrier pseudo random noise signal (BOC(m,n)_{lpf}) (operation 1400).

The process multiplies the filtered binary offset carrier pseudo random noise signal with a local copy of the binary offset carrier (BOC(m)) (operation 1402). In operation 1402, the result is BOC(m,n)_{lpf}×BOC (m).

The process estimates the noise statistics on (operation 1404). In operation 1404, the noise statistics σₙ is estimated as the absolute value of the binary offset carrier pseudo random noise signal and σₙ is multiplied by 6 to estimate the noise. In this example σₙ=sigma(|BOC(m,n)_{lpf}|) where |▪| is the absolute function and sigma (▪) is the function that gives the standard deviation.

The process prepares to remove the binary offset carrier (BOC(m)) from the filtered binary offset carrier pseudo random noise signal (BOC(m,n)_{lpf}) (operation 1406). In operation 1406, BOC(m,n)_{lpf}×BOC(m)+(6×σₙ)×PRN(n). In this example, the PRN(n) is the local copy of the pseudo random noise.

The process removes the binary offset carrier (BOC(m)) to form the restored pseudo random noise (operation 1408). The process terminates thereafter. In operation 1408, restored PRN=sign[BOC(m,n)_{lpf}×subcarrier(m)+(6×σₙ)×PRN(n)], where sign[n<0]=−1, sign[n≥0]=+1.

The restored pseudo random noise with the binary offset carrier removed can now be used in performing the correlation with the pseudo random noise for the source to obtain an ambiguity free correlation.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. For example, one or more of the blocks can be implemented as program instructions, hardware, or a combination of the program instructions and hardware. When implemented in hardware, the hardware can, for example, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. For example, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

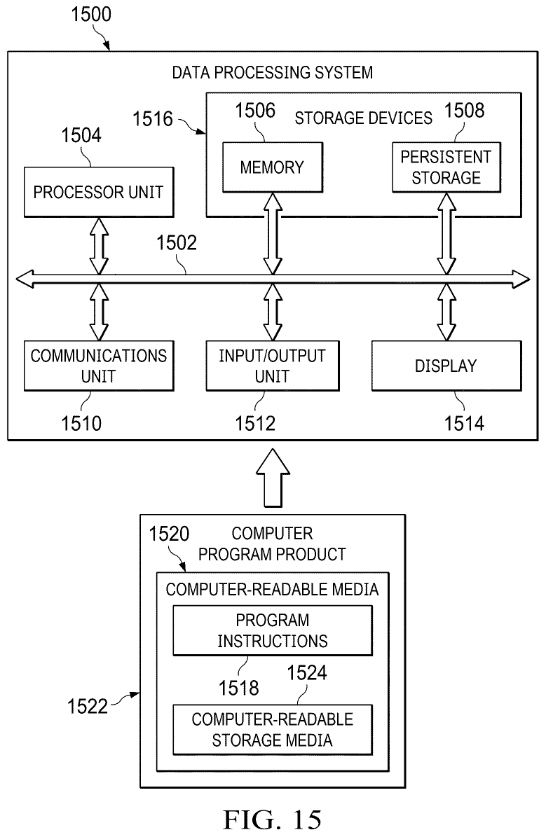

Turning now to FIG. 15, an illustration of a block diagram of a data processing system is depicted in accordance with an illustrative embodiment. Data processing system 1500 can be used to implement computer system 212 in FIG. 2. In this illustrative example, data processing system 1500 includes communications framework 1502, which provides communications between processor unit 1504, memory 1506, persistent storage 1508, communications unit 1510, input/output (I/O) unit 1512, and display 1514. In this example, communications framework 1502 takes the form of a bus system.

Processor unit 1504 serves to execute instructions for software that can be loaded into memory 1506. Processor unit 1504 includes one or more processors. For example, processor unit 1504 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1504 can be implemented using one or more heterogeneous processor systems in which a main processor is present with secondary processors on a single chip. As another illustrative example, processor unit 1504 can be a symmetric multi-processor system containing multiple processors of the same type on a single chip.

Memory 1506 and persistent storage 1508 are examples of storage devices 1516. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 1516 may also be referred to as computer-readable storage devices in these illustrative examples. Memory 1506, in these examples, can be, for example, a random-access memory or any other suitable volatile or non-volatile storage device. Persistent storage 1508 may take various forms, depending on the particular implementation.

For example, persistent storage 1508 may contain one or more components or devices. For example, persistent storage 1508 can be a hard drive, a solid-state drive (SSD), a flash memory, a rewritable optical disk, a rewritable magnetic tape, or some combination of the above. The media used by persistent storage 1508 also can be removable. For example, a removable hard drive can be used for persistent storage 1508.

Communications unit 1510, in these illustrative examples, provides for communications with other data processing systems or devices. In these illustrative examples, communications unit 1610 is a network interface card.

Input/output unit 1512 allows for input and output of data with other devices that can be connected to data processing system 1500. For example, input/output unit 1512 may provide a connection for user input through at least one of a keyboard, a mouse, or some other suitable input device. Further, input/output unit 1512 may send output to a printer. Display 1514 provides a mechanism to display information to a user.

Instructions for at least one of the operating system, applications, or programs can be located in storage devices 1516, which are in communication with processor unit 1504 through communications framework 1502. The processes of the different embodiments can be performed by processor unit 1504 using computer-implemented instructions, which may be located in a memory, such as memory 1506.

These instructions are referred to as program instructions, computer usable program instructions, or computer-readable program instructions that can be read and executed by a processor in processor unit 1504. The program instructions in the different embodiments can be embodied on different physical or computer-readable storage media, such as memory 1506 or persistent storage 1508.

Program instructions 1518 are located in a functional form on computer-readable media 1520 that is selectively removable and can be loaded onto or transferred to data processing system 1500 for execution by processor unit 1504. Program instructions 1518 and computer-readable media 1520 form computer program product 1522 in these illustrative examples. In the illustrative example, computer-readable media 1520 is computer-readable storage media 1524.

Computer-readable storage media 1524 is a physical or tangible storage device used to store program instructions 1518 rather than a medium that propagates or transmits program instructions 1518. Computer readable storage media 1524 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits/lands formed in a major surface of a disc, or any suitable combination thereof.

Computer readable storage media 1524, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 1518 can be transferred to data processing system 1500 using a computer-readable signal media. The computer-readable signal media are signals and can be, for example, a propagated data signal containing program instructions 1518. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1520” can be singular or plural. For example, program instructions 1518 can be located in computer-readable media 1520 in the form of a single storage device or system. In another example, program instructions 1518 can be located in computer-readable media 1520 that is distributed in multiple data processing systems. In other words, some instructions in program instructions 1518 can be located in one data processing system while other instructions in program instructions 1518 can be located in one data processing system. For example, a portion of program instructions 1518 can be located in computer-readable media 1520 in a server computer while another portion of program instructions 1518 can be located in computer-readable media 1520 located in a set of client computers.

The different components illustrated for data processing system 1500 are not meant to provide architectural limitations to the manner in which different embodiments can be implemented. In some illustrative examples, one or more of the components may be incorporated in or otherwise form a portion of, another component. For example, memory 1506, or portions thereof, may be incorporated in processor unit 1504 in some illustrative examples. The different illustrative embodiments can be implemented in a data processing system including components in addition to or in place of those illustrated for data processing system 1500. Other components shown in FIG. 15 can be varied from the illustrative examples shown. The different embodiments can be implemented using any hardware device or system capable of running program instructions 1518.

Thus, the illustrative examples provide a method, apparatus, system, and computer program product for acquiring and tracking signals. In one illustrative example, a method for restoring a pseudo random noise from a received binary offset carrier pseudo random noise signal. The received binary offset carrier pseudo random noise signal is filtered using a filter system to form a filtered binary offset carrier pseudo random noise signal that comprises a range of frequencies in the received binary offset carrier pseudo random noise signal. The binary offset carrier is removed from the filtered binary offset carrier pseudo random noise signal to obtain a restored pseudo random noise. The restored pseudo random noise is correlated with a local replica of the pseudo random noise.

This correlation is used to acquire binary offset carrier pseudo random noise signals transmitted by a particular source that is associated with the pseudo random noise. The illustrative examples enable correlation without ambiguity. As a result, a reduction of at least one of errors in correlation or time to perform correlation occurs.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A method for processing a received binary offset carrier pseudo random noise signal, the method comprising:
receiving the received binary offset carrier pseudo random noise signal, wherein the received binary offset carrier pseudo random noise signal comprises a binary offset carrier and a pseudo random noise;
passing the received binary offset carrier pseudo random noise signal through a filter system to form a filtered binary offset carrier pseudo random noise signal that comprises a range of frequencies in the received binary offset carrier pseudo random noise signal;
multiplying the filtered binary offset carrier pseudo random noise signal with a local replica of the binary offset carrier, wherein the binary offset carrier is removed from the filtered binary offset carrier pseudo random noise signal to form a pseudo random noise signal estimate comprising the pseudo random noise and a noise from the filtered binary offset carrier pseudo random noise signal; and
removing the noise from the pseudo random noise signal estimate using a noise estimate of the noise and a local replica of the pseudo random noise to obtain a restored pseudo random noise.

2. The method of claim 1 further comprising:
correlating the restored pseudo random noise with the local replica of the pseudo random noise.

3. The method of claim 2 further comprising:
extracting data from the received binary offset carrier pseudo random noise signal in response to a correlation peak being present and exceeding a defined threshold, wherein the correlation peak results from correlating the restored pseudo random noise with a local copy of the pseudo random noise.

4. The method of claim 1 further comprising:
determining the noise estimate for the noise in the pseudo random noise signal estimate using a standard deviation of an absolute value of the pseudo random noise signal estimate.

5. The method of claim 1, wherein removing the noise comprises:
adding the noise estimate to the pseudo random noise signal estimate; and
applying a sign function to the pseudo random noise signal estimate with the noise estimate to obtain the restored pseudo random noise.

6. The method of claim 5, wherein the noise estimate is a product of 6 multiplied by a noise sigma to the pseudo random noise signal estimate.

7. The method of claim 1, wherein the filter system is selected from at least one of a low pass filter, a high pass filter, a band pass filter, or a notch filter.

8. The method of claim 1, wherein the received binary offset carrier pseudo random noise signal is received from a satellite in a global navigation satellite system.

9. The method of claim 8, wherein the pseudo random noise uniquely identifies the satellite within the global navigation satellite system.

10. A method for restoring a pseudo random noise from a received binary offset carrier pseudo random noise signal, the method comprising:
filtering the received binary offset carrier pseudo random noise signal using a filter system to form a filtered binary offset carrier pseudo random noise signal that comprises a range of frequencies in the received binary offset carrier pseudo random noise signal; and
removing the binary offset carrier from the filtered binary offset carrier pseudo random noise signal to obtain a restored pseudo random noise; and
correlating the restored pseudo random noise with a local replica of the pseudo random noise.

11. The method of claim 10, wherein removing the binary offset carrier comprises:
multiplying the filtered binary offset carrier pseudo random noise signal with a local replica of the binary offset carrier, wherein the binary offset carrier is removed from the filtered binary offset carrier pseudo random noise signal to form a pseudo random noise signal estimate comprising the pseudo random noise and a noise from the filtered binary offset carrier pseudo random noise signal; and
removing the noise from the pseudo random noise signal estimate to obtain the restored pseudo random noise.

12. The method of claim 11, wherein removing the noise comprises:
determining the noise estimate for the noise in the received binary offset carrier pseudo random noise signal as a standard deviation of an absolute value of the filtered binary offset carrier pseudo random noise signal;
adding the noise estimate to the pseudo random noise signal estimate; and
applying a sign function to the pseudo random noise signal estimate with the noise estimate to obtain the restored pseudo random noise.

13. A receiver system comprising:
a signal processor configured to:
receive a received binary offset carrier pseudo random noise signal, wherein the received binary offset carrier pseudo random noise signal comprises a binary offset carrier and a pseudo random noise;
pass the received binary offset carrier pseudo random noise signal through a filter system to form a filtered binary offset carrier pseudo random noise signal that comprises a range of frequencies in the received binary offset carrier pseudo random noise signal;
multiply the filtered binary offset carrier pseudo random noise signal with a local replica of the binary offset carrier, wherein the binary offset carrier is removed from the filtered binary offset carrier pseudo random noise signal to form a pseudo random noise signal estimate comprising the pseudo random noise and a noise from the received binary offset carrier pseudo random noise signal; and
remove the noise from the pseudo random noise signal estimate using a noise estimate of the noise and a local replica of the pseudo random noise to obtain a restored pseudo random noise.

14. The receiver system of claim 13, wherein the signal processor is configured to:
correlate the restored pseudo random noise with the local replica of the pseudo random noise.

15. The receiver system of claim 14, wherein the signal processor is configured to:
extract data from the received binary offset carrier pseudo random noise signal in response to a correlation peak being present and exceeding a defined threshold, wherein the correlation peak results from correlating the restored pseudo random noise with a local copy of the pseudo random noise.

16. The receiver system of claim 13, the signal processor is configured to:
determine the noise estimate for the noise in the pseudo random noise signal estimate using a standard deviation of an absolute value of the pseudo random noise signal estimate.

17. The receiver system of claim 13, wherein in removing the noise, the signal processor is configured to:
add the noise estimate to the pseudo random noise signal estimate; and
apply a sign function to the pseudo random noise signal estimate with the noise estimate to obtain the restored pseudo random noise.

18. The receiver system of claim 17, wherein the noise estimate is a product of 6 multiplied by a noise sigma to the pseudo random noise signal estimate.

19. The receiver system of claim 13, wherein the filter system is selected from at least one of a low pass filter, a high pass filter, a band pass filter, or a notch filter.

20. The receiver system of claim 13, wherein the received binary offset carrier pseudo random noise signal is received from a satellite in a global navigation satellite system.

21. The receiver system of claim 20, wherein the pseudo random noise uniquely identifies the satellite within the global navigation satellite system.

22. A receiver system configured to:
filter a received binary offset carrier pseudo random noise signal using a filter system to form a filtered binary offset carrier pseudo random noise signal that comprises a range of frequencies in the received binary offset carrier pseudo random noise signal;
remove the binary offset carrier from the filtered binary offset carrier pseudo random noise signal to obtain a restored pseudo random noise; and
correlate the restored pseudo random noise with a local replica of the pseudo random noise.
